(19) United States
(12) Patent Application Publication
(10) Pub. No.: US 2015/0051957 A1
(43) Pub. Date: Feb. 19, 2015

(54) MEASURING CUSTOMER EXPERIENCE VALUE

(71) Applicant: Oracle International Corporation, Redwood Shores, CA (US)

(72) Inventors: Jeffrey Griebeler, Austin, TX (US); Brian Curran, Washington, DC (US)

(73) Assignee: Oracle International Corporation, Redwood Shores, CA (US)

(21) Appl. No.: 13/967,971

(22) Filed: Aug. 15, 2013

(51) Int. Cl. G06Q 10/06

(52) U.S. Cl. CPC G06Q 10/06395
USPC 705/7.41

(57) ABSTRACT

A disclosed method includes determining a customer experience value (CXV) of an entity by a server computer. The CXV may be determined by calculating a customer acquisition value of the entity, calculating a customer retention value of the entity, and calculating an operation efficiency value of the entity. The customer acquisition value may be based on at least one of a measure of acquisition performance of the entity or a measure of operational performance of the entity. The customer retention value may be based on at least one of a measure of customer retention or a measure of service quality. The operation efficiency value may be based on at least one of a measure of operating costs of the entity or a measure of strategic costs of the entity. The method includes using, by a customer relationship management application, the determined CXV to indicate a measure of customer satisfaction.

### TECHNICAL FIELD

Embodiments of the present invention relate generally to methods and systems for managing customer experience of an entity and more particularly to measuring customer experience of the entity using a customer relationship management (CRM) system.

### BACKGROUND OF THE INVENTION

A CRM system enables a business to manage interactions between the business and its customers. A CRM system may automate and manage synchronization, sales, marketing, customer service, and/or technical support. A business that desires to manage and improve customer service provided by the business may frequently utilize a CRM system to obtain information about the business (e.g., financial information), customer service, and management. Such information may enable executives and managers to assess the impact that individual factors that may have on customer experience.

Customers increasingly ask for custom solutions to their problems, often times causing businesses to compete against each other. In an increasingly competitive environment, businesses must find new points of differentiation, not only in products but also in customer experience offered to its customers. In fact, customer experience is emerging as a significant, competitive differentiator between vendors in many markets. As a result, businesses are focused on improving customer experience provided to customers, which may have a direct and indirect impact on sales and may improve customer loyalty to support future growth of such companies. A CRM system may enable such businesses to further analyze and determine customer experience. Customer experience may be generally known as CX, which is frequently viewed as a component of CRM or brand business strategy.

However, unlike financial metrics, many of which are measurable and quantifiable for assessing business performance, customer experience is an intangible and difficult to measure. Based on a business's view of factors influencing customer experience, customer experience may be defined and interpreted differently through the lens of a particular business. Some business's may rely on metrics that may include different types of measurements (e.g., customer feedback information, customer service statistics, and/or financial metrics) to assess customer experience. These measurements, while indicative, may be difficult to be analyzed together as a combined, reflective measure of customer satisfaction or interaction. Further, CRM systems may not be configured to calculate a value that truly represents a combination of the factors that impact customer experience for a particular type of business. For example, many CRM systems may ignore consideration of categories that may seem unrelated, but that are useful in determining an overall impact to an organization's customer experience when these categories are considered together. What is needed is a CRM system that can leverage and take advantages of the resources often available in CRM systems to improve how customer experience is measured and analyzed.

### BRIEF SUMMARY OF THE INVENTION

Embodiments of the present invention are directed to a system for determining a measure of customer experience of an entity (e.g., a business or an organization). A measure value of customer experience is helpful for identifying health or status of customer experience provided to customers that interact with the entity. Such a measured value may be useful in enabling executives, analysts, leaders, or any person concerned with analyzing customer experience of the entity to effectively assess customer experience most beneficial to a type of business of the entity.

In a computing system, such as a customer relationship management (CRM) system, customer experience may be quantified by determining a value (“customer experience value”, or CXV), which can be based on calculation of values related to performance for the entity in one or more areas of business, such as: (1) acquisition, (2) retention, and (3) efficiency. The CXV represents a measure that is based on a combination of each area of performance for an entity which may be considered as affecting customer experience. Measuring the CXV goes beyond just the CRM system, as it may include measurement of interactions between a company and its customers. These interactions can be supported by a CRM system, but additionally backend systems such as enterprise resources planning (ERP) (e.g., logistics, billing, inventory mgmt, etc.), employees who interact with the customers, business processes, business policies, POS, and internet systems. The areas of performance may vary from entity to entity, as the CXV provides a better indication of customer experience based on consideration, from a perspective of the entity, of areas of performance that impact the entity. Based on factors such as type of industry and operation of an entity, the areas for consideration that affect customer experience may vary for each entity. Further, some areas may have a greater affect or impact on customer experience, such that they may be given greater weight or consideration. Generally, the CXV may be determined based on a combination of values (e.g., a summation of values), each related to performance in one or more particular areas of business including customer acquisition, customer retention, and operation efficiency. The CXV may be used by a CRM application to indicate a measure of customer satisfaction. For example, the CRM application may generate information of customer satisfaction (e.g., a report and a metric) determined based on the CXV. The generated information may indicate a value of customer satisfaction that can be determined based on a relationship of CXV's to values indicating customer satisfaction. Further, the CRM application may provide the generated information in a graphical interface (e.g., a dashboard view) that can be used for subsequent analysis of customer experience.

The customer acquisition value may be based on measured values related to an amount of opportunities generated by the entity, such as a count of visitor and customer traffic and a measure of brand visibility and following. The customer acquisition value may be based on, among others, a measured values related to brand equity (e.g., an average value of an order, conversion rate for customers, and cost per order) and measured values related to market share of the entity. A value related to retention (“customer retention value”) may be a measure of the entity's ability to retain customers. The customer retention value may be based on measured values related to customer loyalty (e.g., a measure of repeat purchasers), to advocacy (e.g., a measure of customers that recommend the entity), and to wallet share of a customer. A value related to efficiency (“operation efficiency value”) may be a ratio of delivery of services or products to cost. The operation efficiency value may be based on operation efficiency of the entity, such as measured values related to the efficiency of the entity (e.g., return on invested capital of the entity or economic value added to the entity), to cost of operation for the entity (e.g., cost of sales, marking costs, or service costs), and to productivity of the entity (e.g., average service time).

Embodiments of the invention provide systems and methods for determining a customer experience value based on calculation of measured values of individual areas related to performance of the entity. According to one embodiment, a method includes determining, by a server computer, a CXV by calculating a customer acquisition value, calculating a customer retention value, and calculating an operation efficiency value. The server computer may access one or more databases (e.g., databases in a customer relationship management system) to obtain information such as product and service information, business financial and marketing information, customer feedback information, and/or customer service information to determine the customer acquisition value, the customer retention value, and the operation efficiency value, or a combination thereof. The method further includes using, by a customer relationship management (CRM) application at the server computer, the determined customer experience value to indicate a measure of customer satisfaction.

The customer acquisition value of the entity the customer acquisition value is calculated based on at least one of a measure of acquisition performance of the entity or a measure of operational performance of the entity. The customer retention value of the entity is calculated based on at least one of a measure of customer retention or a measure of service quality. The operation efficiency value is calculated based on at least one of a measure of strategic costs of the entity or a measure of operating costs of the entity. The customer experience value is determined based on a combination (e.g., a summation) of the customer acquisition value, the customer retention value, and the operation efficiency value.

In another embodiment, a system is disclosed that includes a processor and a memory coupled with and readable by the processor and storing therein a set of instructions which, when executed by the processor, cause the processor to determine a customer experience value of an entity. The customer experience value is determined by calculating a customer acquisition value, calculating a customer retention value, and calculating an operation efficiency value. The customer acquisition value of the entity the customer acquisition value is calculated based on at least one of a measure of acquisition performance of the entity or a measure of operational performance of the entity. The customer retention value of the entity is calculated based on at least one of a measure of customer retention or a measure of service quality. The operation efficiency value is calculated based on at least one of a measure of strategic costs of the entity or a measure of operating costs of the entity. The customer experience value is determined based on a sum of the customer acquisition value, the customer retention value, and the operation efficiency value.

In yet another embodiment, a computer-readable memory is disclosed including a set of instructions stored thereon which, when executed by a processor, cause the processor to determine a customer experience value of an entity. The customer experience value is determined by calculating a customer acquisition value, calculating a customer retention value, and calculating an operation efficiency value. The customer acquisition value of the entity the customer acquisition value is calculated based on at least one of a measure of acquisition performance of the entity or a measure of operational performance of the entity. The customer retention value of the entity is calculated based on at least one of a measure of customer retention or a measure of service quality. The operation efficiency value is calculated based on at least one of a measure of strategic costs of the entity or a measure of operating costs of the entity. The customer experience value is determined based on a sum of the customer acquisition value, the customer retention value, and the operation efficiency value.

These and other embodiments of the invention are described in further detail below.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating, at a high-level, functional components of a customer relationship management (CRM) system determining a customer experience value according to one embodiment of the present invention.

FIG. 4 is a flowchart illustrating a process performed according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the invention provide systems and methods for determining a customer experience value (hereinafter referred to as “CXV”) based on calculation of measured values of individual areas related to performance of the entity. More specifically, embodiments of the present invention provide for determining the CXV by calculating, by a server computer (e.g., a server computer of a computing system such as a customer relationship management system, hereinafter referred to as “CRM” system) a customer acquisition value, calculating, by the server computer, a customer retention value, and calculating, by the server computer, an operation efficiency value. In some embodiments, an application of a CRM system may use the CXV to indicate a measure of customer satisfaction. Because customer satisfaction may be affected by customer experience, the CXV may have a relationship with customer satisfaction. As such, the CXV may be used by a CRM application to generate information such as a metric, a measure, a value, a report, or other information, which is expressive of customer satisfaction as a function of the CXV value based on a relationship between customer satisfaction and customer experience. The CRM application may present the generated information in a graphical interface (e.g., a dashboard view or report display), where it can be further analyzed with respect to customer experience. Although embodiments described herein as being included in or implemented using a CRM system, it may be appreciated that the invention may be performed by a computing system external to the CRM system. Such an external computing system may access a CRM system for information used to determine the CXV. Since a system of the present invention may have access to information about the entity (e.g., product/service information, customer feedback information, customer service information, and/or business information), it would be a logical extension for the system to use available information to determine a measure of customer experience (e.g., a CXV).

Embodiments of the present invention enable a computing system to selectively consider a plurality of key performance indicators (hereinafter referred to as “KPI”) associated with different areas of operation to enable an entity to customize how customer experience is measured. Effectively, such a system enables the entity to view customer experience through the lens of the entity. Further, the system is adaptable to permit the CXV to be determined based on other factors that become of importance or to permit the CXV to exclude consideration of certain factors. The system reduces time to gather and consider information relevant in determining the CXV because the information in a CRM system may be current and easily accessible from a single source that manages the information needed to determine the CXV. Additionally, when the present invention is implemented in a CRM system, the CRM system may be able to automatically adjust operation of other business functions provided by the CRM system in response to the CXV. Various additional details of embodiments of the present invention will be described below with reference to the figures.

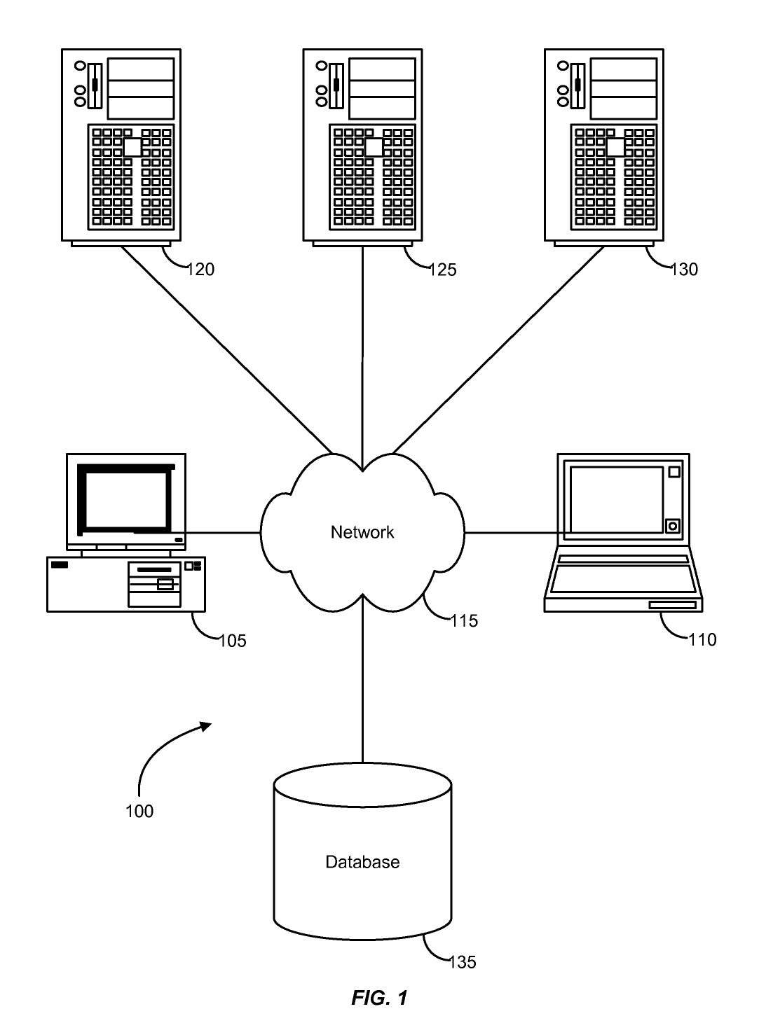

FIG. 1 is a block diagram illustrating components of an exemplary operating environment in which various embodiments of the present invention may be implemented. The system 100 can include one or more user computers 105, 110, which may be used to operate a client, whether a dedicate application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., a network 115 described below) and/or displaying and navigating web pages or other types of electronic documents. Although the exemplary system 100 is shown with two user computers, any number of user computers may be supported.

In some embodiments, the system 100 may also include the network 115. The network may can be any type of network familiar to those skilled in the art that can support data communications using any of a variety of commercially-available protocols, including without limitation TCP/IP, SNA, IPX, AppleTalk, and the like. Merely by way of example, the network 115 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110. In particular embodiments, one or more of the server computers 120, 125, 130 may be associated with or operating in a CRM system. One or more of the server computers 120, 125, 130 may be configured to perform the methods as described herein.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10 g or Oracle 11g, that is adapted to store, update, and retrieve data in response to SQL-formatted commands.

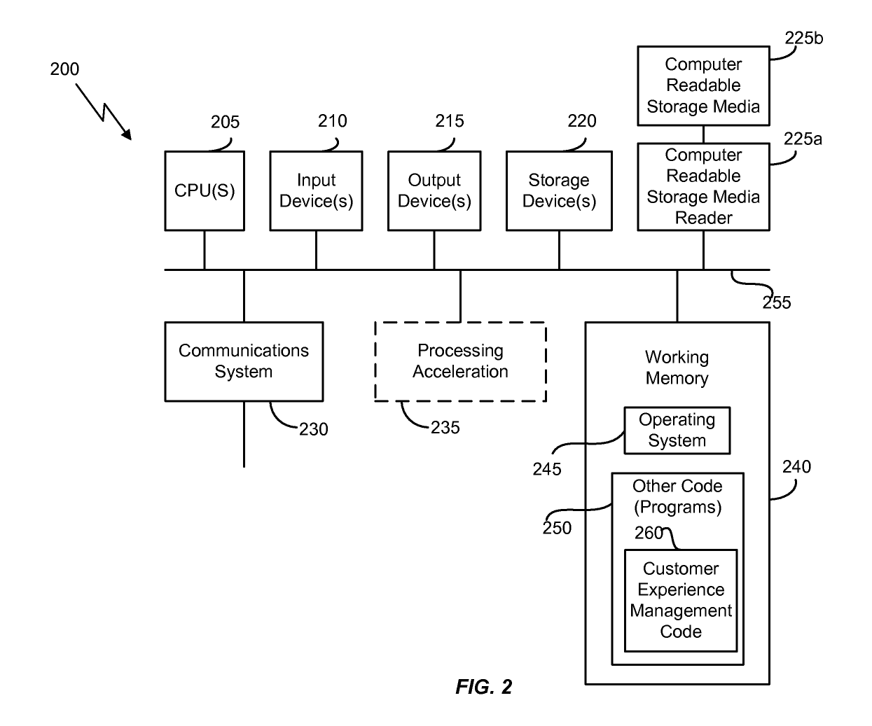

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein. For example, the code 250 may include customer experience management code 250 that determines a measure of customer experience of an entity (e.g., a business or an organization).

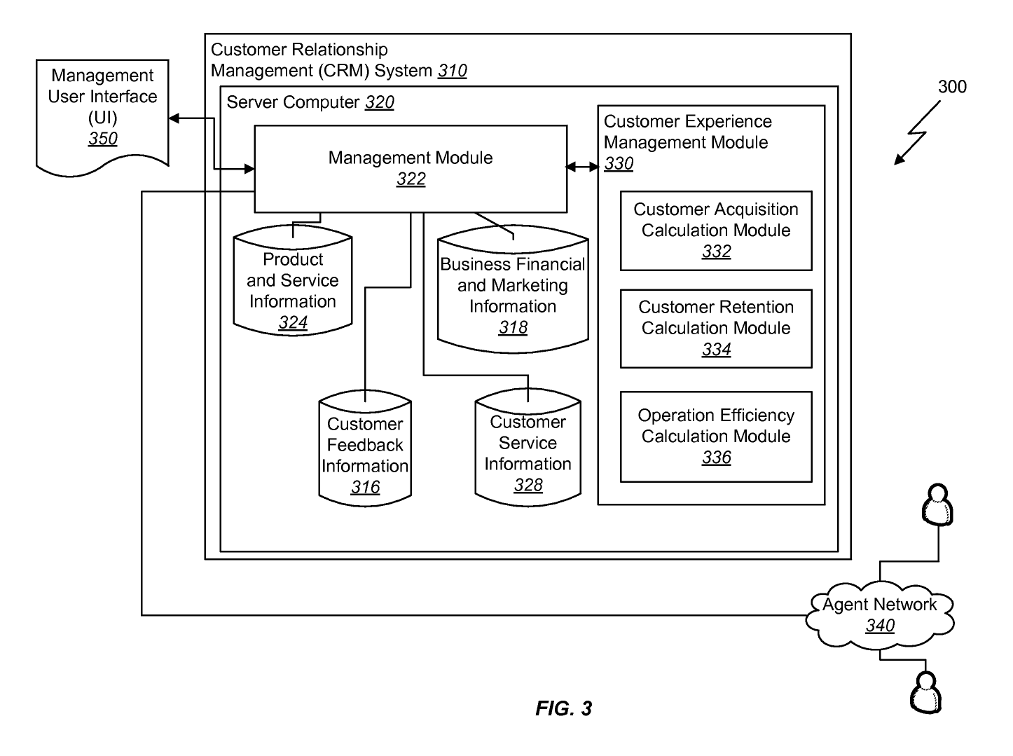

FIG. 3 is a block diagram illustrating, at a high-level, functional components of a system to determine a measure of customer experience of an entity (e.g., a business or an organization), generally designated 300. In this example, the system 300 may include a CRM system 310 that may be executable on a server computer or another computing device as described herein. While the embodiment shown in FIG. 3 is implemented in a CRM system 310, other computing systems may be implemented that have access to information which enables a measure of customer experience to be determined. The CRM system 310 may enable a user (e.g., an administrator, an operator, a developer, or a business executive) to manage services provided by the entity, such services including sales, service, marketing, Internet and mobile commerce, a loyalty system, or a combination thereof. The CRM system 310 may further enable its user to obtain information indicating a measure of customer experience for the entity.

The CRM system 310 may include a server computer 320 that is configured to operate the CRM system 310. The server computer 320 may one or more computing modules including a management module 322 that is configured to perform one or more operations to manage the CRM system 310. For example, the management module 322 may create, update, communicate, determine, or a combination thereof, information stored in one or more memory storage devices associated within or included in the server computer 320. The one or more memory storage devices of the CRM system 310 may include or be coupled to a customer feedback database (customer feedback information 316), a product and service information database (product and service information 324), a business information database (business financial and marketing information 318), a customer service information database (customer service information 328), or a combination thereof. The customer feedback information 316 may include customer surveys, statistics based on the customer surveys, other information related to customer feedback, or a combination thereof. The product and service information 324 may include information about products, services, or both, offered by the entity. The business financial and marketing information 318 may include financial information (e.g., operating costs, costs associated with customer service, and sales costs) and marketing information (e.g., marketing costs, return on investment, or information related to advertising), or both. The customer service information 328 may include customer records, reports, customer feedback, statistics associated with customer service, or a combination thereof. The information stores in the databases 316, 318, 324, 328 may be gathered by the CRM system 310 or may be obtained from a computing system coupled to the CRM system 310.

A management user interface 350 may be coupled to the CRM system 310 via the management module 322 to enable access to the CRM System 310 to control management and operation of the CRM system 310. The management user interface 350 may include a graphical user interface (e.g., a web interface or a computer graphical user interface), a communication user interface, other type of interface, or a combination thereof, configured to enable communication to the CRM system 310. The management user interface 350 may be accessible via a computing device communicatively coupled to the CRM system 310. Alternatively, or additionally, the CRM system 310 may be coupled to other computing systems or networks (e.g., an agent network 340) of the entity that provide or access the information stored in the CRM system 310. The CRM system 310 can support a number of users, such as end users of a product or service, who request support or service, and can process those requests in order to connect or direct the requesting users to one or more agents accessible through an agent network 340. For example, the server computer 320 can provide one or more interfaces including but not limited to web pages, email addresses, phone lines, chat and/or instant messaging, and/or any of a variety of other communication channels to customer users of the system. Through these channels/interfaces, the customers can make requests for support that may include questions to be answered by the agents.

The server computer 320 may include a customer experience management module 330 that is configured to manage customer experience for an entity associated with the CRM system 310. The customer experience management module 330 may communicate with the management module 322 to access information stored in the one or more memory storage devices of the CRM system 310. The customer experience management module 330 may be configured to perform one or more methods described herein. The customer experience management module 330 may analyze and determine information to provide a measure of customer experience or the CXV for the entity.

In a particular embodiment, the CXV may represent, or be indicative of a score (e.g., a score value of 0 to 100) that indicates a measure of quality of customer experience (e.g., strength of customer experience), a level that indicates a status of customer experience, or both, provided by the entity to a customer. For example, an entity may use a CRM system to determine a measure of quality or status of the customer experience based on comparison of the CXV value to one or more predetermined ranges of CXV value. Based on the comparison, the CRM system may determine a score for customer experience that corresponds to the predetermined range of values. The predetermined range of values may be ascertained based on analysis of historical CXV values. Alternatively, the CRM system may determine a level (e.g., poor, fair, good, excellent, or superior) for the customer experience based on the predetermined range of values that includes the CXV. The CXV may enable the entity to better understand effectiveness of customer relationship strategies and/or customer experience provided by the entity. Each entity may determine the predetermine ranges based on analysis of their historical CXV and measures of customer experience. Thus, the CXV, which is calculated based on factors weighted by an entity, may provide a more accurate measure of customer experience. Such an understanding gained from the CXV will enable the entity to improve response to customer's needs and preferences, which may lead to an increase in business and sales. A determination as to calculating the CXV is described below in further detail.

The customer experience management module 330 may include modules that analyze and determine customer experience based on information in the CRM system 310, such as the information stored in one or more of the databases 316, 318, 324, 328. While FIG. 3 illustrates modules to perform calculations to determine a measure of customer experience, the customer experience module 330 may include any number of modules that are configured to analyze and calculate information for determining a measure of customer experience. In a particular embodiment, the customer experience management module 330 includes a customer acquisition calculation module 332, a customer retention calculation module 334, and an operation efficiency calculation module 336. Individually, one or more of the modules 332, 334, 336 included in the customer experience management module 330 may determine a measure of customer experience (e.g., the CXV) based on information stored in the databases 316, 318, 324, 328.

The customer acquisition calculation module 332 may calculate a customer acquisition value that provides a measure related to an entity's ability to increase customer base. The customer acquisition value may be based on measured values related to an amount of opportunities generated by the entity, to brand equity (e.g., an average value of an order, conversion rate for customers, and cost per order), and to market share of the entity. The customer retention calculation module 334 may calculate a customer retention value that is related to a measure of an entity's ability to retain customers. A customer retention value may be based on measured values related to customer loyalty (e.g., a measure of repeat purchasers), to advocacy (e.g., a measure of customers that recommend the entity), and to wallet share of a customer. The operation efficiency calculation module 336 may calculate an efficiency value that is ratio of delivery of services or products to cost. The efficiency value may be an operation efficiency value based on measured values related to the efficiency of an entity (e.g., return on invested capital of the entity or economic value add of the entity), to cost of operation for the entity (e.g., cost of sales, marking costs, or service costs), and to productivity of the entity (e.g., average service time).

In use, an entity may implement the CRM system 310 to manage an entity's interactions with current and future customers. A user may access the CRM system 310 via the management user interface 350 to manage, access, and share information related to the entity. A user accessing the CRM system 310 may be an employee of the entity with a duty to assess and understand customer service and support provided by the entity. In a particular embodiment, the user may access the CRM system 310, via the management UI 350, to obtain information about customer experience provided by the entity, such as a measure of customer experience. The measure of customer experience may enable the employee to make a determination as to a quality or level of customer support and/or service provided to customers.

In a particular embodiment, the CRM system 310 may execute the management module 322 in response to operation of the CRM system 310, such as in response to a communication sent via the management UI 350. The management module 322 may store or access the information included in one or more of the databases 316, 318, 324, 328. The management module 322 may request information, such as a CXV, produced by the customer experience management module 330 to determine customer experience of the entity. The information (e.g., the CXV) about the customer experience of the entity, besides providing a measure of customer experience, may be used to perform analysis to determine status (e.g., a score or a level) of customer experience with respect to the entity. For example, the CXV may be compared to historical data of customer experience of the entity (e.g., historical CXV's) to determine the status. The management module 322 or the customer experience management module 330 may compare the CXV to predetermined ranges of CXV's specified by the entity. The predetermined ranges of CXV's may be based on historical CXV's that suggest a level or status of customer experience (e.g, poor customer experience, fair customer experience, good customer experience, excellent customer experience, or superior customer experience). The historical CXV's may be determined based on particular categories of types of KPIs that enable the entity to determine levels of customer service corresponding to CXV's. In a particular embodiment, the level or status of customer experience may be determined based on the predetermined range that includes the CXV. In this manner, the entity may be able to more accurately determine customer experience relying on factors that affect the entity, which enable the entity to determine relationships between changes in customer experience and particular factors that are important to the entity.

In another example, the CXV may be used to determine a score of customer experience that indicates a strength or quality of customer experience. The entity operating the CRM system 310 may provide information to the CRM system 310 that enables the score to be associated with the CXV value. The customer experience management module 330 may determine a score of customer experience such that a higher a CXV may be assigned a higher score indicating a greater quality of customer experience. In other embodiments, the score may be assigned a lower value corresponding to a lower CXV which may correspond to a greater quality of customer experience based on the factors used to determine the CXV. In some embodiments, the quality or level of customer experience may be inversely proportional to the CXV. The CRM system 310 enables the entity to customize how the CXV is calculated to enable the CXV to represent a measure of factors deemed important in the eyes of the entity. The CXV provides a measure that enables the entity to perform further analysis to assess the customer experience.

The customer experience management module 330 may communicate with the module 322 to access, from one or more of the databases 316, 318, 324, 326, information useful for determining the CXV. For example, customer experience management module 330 may request the management module 322 for information such as product service rates and customer feedback about a product (e.g., statistics on customer recommendations, service costs, or customer satisfaction ratings) accessible from the product and service information 324. To determine the CXV, the customer experience management module 330 may execute one or more of the modules 332, 334, 336 to calculate a distinct measure of a factor (e.g., acquisition, retention, or operation) that has been identified by the entity as impacting customer experience. In a particular embodiment, the customer experience management module 330 may calculate the CXV by determining a sum of a customer acquisition value, a customer retention value, and an operation efficiency value. In this embodiment, the customer experience management module 330 may execute the customer acquisition calculation module 332 to determine the customer acquisition value, may execute the customer retention calculation module 334 to determine the customer retention value, and may execute the customer operation efficiency calculation module 336 to determine an operation efficiency value. In other embodiments, the customer experience management module 330, or one or more of the modules 332, 334, 336, may calculate at least one of the customer acquisition value, the customer retention value, or the operation efficiency value, respectively, based on a particular weighted value. In a particular embodiment, an entity may provide information to the CRM system 310 such that a distinct weight value (e.g., a ratio value of 0.0 to 1.0) may be applied to each of the customer acquisition value, the customer retention value, and the operation efficiency value. For example, each of the customer acquisition value, the customer retention value, and the operation efficiency value may be multiplied by the distinct weight value. Different entities may place different emphasis on each of the customer acquisition value, the customer retention value, and the operation efficiency value, such that it may be desirable to place a distinct weight value to one or more of the values considered more important than the other. The resulting values of the customer acquisition value, the customer retention value, and the operation efficiency value after application of a weight value may be then be used to determine the CXV as described herein.

### 1. Acquisition Value

The customer acquisition value may be an important consideration for determining overall customer experience because a measure of an organization's acquisition ability to increase its customer base may be based on a customer's experience in dealing with the entity. The customer experience may affect the ability of an entity to gain customers, such that a positive customer experience may be reflected by an increase in customers base or an adoption of a product or service from an entity. Thus, customer acquisition may be indicative of customer experience for an entity.

The customer acquisition module 332 calculates a customer acquisition value based on consideration of factors, such as an amount of opportunities generated by the entity, a measure of brand equity (e.g., an average value of an order, conversion rate for customers, and cost per order), and a measure of market share of the entity. In a particular embodiment, the customer acquisition value may be calculated based on key performance indicators (KPI) including one or more strategic acquisition KPI's, one or more operational acquisition KPI's, or both, which indicate performance related to customer acquisition of an entity. For example, the measure of acquisition performance may be based on a calculation (e.g., a summation) of one or more strategic acquisition KPI's as described herein. The measure of operation performance may be based on a calculation (e.g., a summation) of one or more operational acquisition KPI's. In a particular embodiment, the customer acquisition module 332 may determine the customer acquisition value based on a calculation using a measure of acquisition performance, a measure of operational performance, or both. For example, the customer acquisition value may be based on a sum of the measure of the acquisition performance and the measure of operational performance.

A. Strategic Acquisition KPI's

Direct traffic is a strategic KPI that may be a measure of direct customer traffic by customers (e.g., a new customer or an existing customer) to an entity occurring as a result of a specific action by the entity that is intended to drive interaction with the entity. The interaction with the entity may be tied to a particular activity associated with the entity, such as purchasing a particular product. The specific action that may drive interaction with the entity may include advertising (e.g., sponsored advertising or direct mail advertising campaigns), intentional product search engine optimization, email communication, telemarketing communication, internet-based communication (e.g., Tweet®), communication via a social networking website (e.g., Facebook®), other marketing efforts, or a combination thereof. In a particular embodiment, direct traffic may be a measure of traffic of the entity occurring based on a specific action of the entity intended to drive the traffic. For example, direct traffic may be based on a summation of customers (e.g., new customers, existing customers, or both) who visit the entity's website as a result of action by the entity, such as email marketing, intended to drive interaction with the entity. In another example, direct traffic may be a summation of customers that visit a physical store of the entity as a result of an action by the entity, such as advertising.

Indirect traffic is a strategic KPI that may be a measure based on indirect customer traffic by customers (e.g., a new customer or an existing customer) to an entity occurring as a result of an action by the entity intended to raise awareness of the entity's brand or product(s). In other words, a customer interacts with the entity via an intermediary activity (e.g., an activity not directly related to interaction with the entity for a particular brand or product) that leads to interaction with the entity. The action by the entity may not be designed to cause a person to initiate interaction with the entity. The intermediary activity may include product placement advertising (e.g., product placement in a movie), viral marketing, mobile applications, introductory membership or access to a product (e.g., “freemium” products), general web traffic, communications using social media (e.g., Tweet®), brand reputation, or a combination thereof. In a particular embodiment, indirect traffic may be a measure of customer traffic (e.g., new customers and existing customers) of the entity occurring based on an action of the entity intended to raise awareness of the entity's product(s) or brand. For example, indirect traffic may be based on a summation of customers (e.g., new customers, existing customers, or both) who visit the entity's based on an action of the entity (e.g., communicate posted via a social media website) intended to raise awareness of the entity's product.

Unidentified traffic is a strategic KPI that may be a measure based on customer traffic by customers (e.g., a new customer or an existing customer) to an entity where a source that initiated the customer traffic is not identifiable. The source may not be identifiable when the traffic is not caused by a specific action by the entity that is intended to drive interaction with the entity or an action of the entity intended to raise awareness of the entity's product(s) or brand. In a particular embodiment, unidentified traffic may be a measure of traffic of the entity that is not included in direct traffic or indirect traffic as described herein.

Brand mentions is a strategic KPI that may be a measure based on a count of instances when the entity has been mentioned (e.g., publicized, cited in an article, discussed, etc.) during a time period. In a particular embodiment, brand mention may be calculated by determining a sum of all mentions of the entity over a period of time.

Conversion Rate is a strategic KPI that may be a measure of a number of interactions that occur for a completed sales transaction. The interactions may include a sales call or visits to a web site of the entity. A sales transaction is considered completed when an order is placed. In particular embodiments, the number of interactions do not include communications or visits to a web site for service. In a particular embodiment, the conversation rate may be calculated by determining a ratio of total number of completed sales transactions with the entity and a total number of interactions with the entity (e.g., a service call or a call to place an order). The ratio may be determined by dividing the total number of completed sales transactions by the total number of interactions. For example, a conversion rate for a contact center of the entity may be a total number of converted calls divided by a total number of sales calls (e.g., sales calls). The customer experience calculation module 330 may be configured to determine the conversion rate based on information accessed by the CRM system 310 from a third party computing system that includes a web analytics tool (e.g., Google Analytics® or Omniture®).

Rate of adoption is a strategic KPI that may be a measure of a spread or adoption of an idea, a technology, a service, or a combination thereof, in a particular demographic group of people. The demographic group may be based on a culture, a population, a region of a geographic location, or a combination thereof. Adoption or spread of an idea may vary between entities. An entity may define what adoption of an idea means before determining a rate of adoption. In a particular embodiment, the rate of adoption may be a ratio of customers acquired and a total number of customers during a time period. In another particular embodiment, the rate of adoption may be measured by dividing a total number of adopted customers by a total audience. The total audience may include a total number of people in the demographic group of people. A rate of adoption may be further assessed based on the rate of adoption calculated over a period of time.

Average order value (AOV) is a strategic KPI that may indicate a mean (average) value (e.g., mean monetary value) of purchases for an entity. The mean monetary value may be determined for an aggregate number of purchases for the entity. The mean monetary value may be also determined for purchases with regard to a particular channel or segment of business (e.g., income level or geography) for the entity. In a particular embodiment, the mean monetary value for a target group (e.g., a segment) is calculated based on dividing a total sales revenue (for the segment) by a total number of sales transaction for the segment. For example, the mean monetary value may be an average monetary value of an order corresponding to a product offered by the entity.

B. Operational Acquisition KPI's

Marketing campaign effectiveness is an operational KPI that may be based on a measure of return on investment for an entity's campaign initiative. The return on investment of a campaign may provide an indication effectiveness of advertising to attract customers to the entity. In a particular embodiment, the return on investment of a campaign may be calculated by determining a ratio of marketing revenue of the entity and marketing investment of the entity, the revenue based on a difference between a net marketing revenue of the entity and the marketing investment. For example, return on investment ratio may be calculated by dividing a net campaign revenue subtracted from a marketing investment by a marketing investment. Marketing investment may be based on an amount of money invested for marketing the campaign. The return on investment may be calculated using other equations that provide an indication of a return on investment for advertising campaign(s).

Pages per visit is an operational KPI that may be an average number of web pages viewed by a customer on a website of the entity during a single visit to the website. Pages per visit is useful for measuring customer experience as it an indicator of a customer's interest in an entity. A higher number of web pages viewed suggests the customer is having a positive customer experience. The pages per visit is an indicator of a likelihood of a purchase, such that a greater number of pages viewed indicates a customer is likely to conduct a sale transaction. In a particular embodiment, the customer experience calculation module 330 may be configured to determine the pages per visit based on information accessed by the CRM system 310 from a third party computing system using a web analytics tool (e.g., Google Analytics® or Omniture®).

Shopping cart abandonment is an operational KPI that may be determined based on a number of instances that a potential customer removes an item (e.g., a product or a service) from a shopping cart and fails to purchase the item. Shopping cart abandonment may provide a measure of a ratio of new customers to returning customers. For example, shopping cart abandonment may be determined by a ratio of a number of new visitors to a website and the measure of repeat visitors to the website. In a particular embodiment, the customer experience calculation module 330 may be configured to determine a measure indicating shopping cart abandonment based on information accessed by the CRM system 310 from a third party computing system (e.g., a business analytics provider) using a web analytics tool (e.g., Google Analytics® or Omniture®).

Frequency of visits is an operational KPI that may be calculated based on an amount of (repeat) visits that a customer makes to the entity over a period of time. The frequency of visit may be based on a number of visits to a website of the entity, a physical store of the entity, or both. The frequency of visits may indicate that the customer has a positive customer experience if the customer repeatedly visits the entity. In another particular embodiment, the customer experience calculation module 330 may be configured to determine the frequency of visits based on information accessed by the CRM system 310 from a third party computing system using a web analytics tool (e.g., Google Analytics® or Omniture®).

Items per order is an operational KPI that may be an average number of products, services, or both, that are ordered by a customer in a sales order. The customer acquisition calculation module 332 may be configured to determine the items per order by dividing a total number of unique items in an order by a total number of items in the order.

Up-Sell Cross-Sell Rate is an operational KPI that may be a number of customers that accept an alternative or augmented offer. In a particular embodiment, the up-sell cross sell rate may be calculated as a ratio of offers accepted by customers of the entity and a total number of offers made to the customers by the entity. An up-sell item relates to an offer that is more beneficial to the entity. For example, up-sell items may be a more expensive item, a higher profit item, disposition of sale merchandise, or a combination thereof. A cross-sell item is an item that is related to an original desired item. For example, a cross-sell item may be an item, such as expedited delivery, insurance, or accessories, which is offered with another item for purchase. The up-sell and/or cross-sell rate may cause an increase in a number of items per order and/or an average order value. In a particular embodiment, the up-sell rate may be measured by calculating a number of customers that accept an offer divided by the total number of offers made (sales attempts).

Average revenue per user (ARPU) is an operational KPI that may be a measure indicating an average revenue an entity derives from a single customer or user for a period of time. The ARPU may be calculated by dividing a total amount of revenue generated by an entity by a total number of unique customers.

### 2. Retention Value

Customer retention relates to an entity's ability to retain customers, which may be directly or proportionally related to customer experience. An entity that has a greater retention rate may be likely be offering a proportionally greater or better customer experience which may proportionally affect customer retention. The customer retention value may be determined using measures of factors that have a relationship or that affect customer retention. In a particular embodiment, the customer retention calculation module 334 may calculate a customer retention value based on a consideration of factors, such as a measure of customer loyalty (e.g., a measure of repeat purchasers), of advocacy (e.g., a measure of customers that recommend the entity), and of wallet share of a customer. While embodiments described herein mention factors that may be used to determine a measure of retention, the customer retention value may be determined by other factors that express or affect an entity's ability to retain customers.

The customer retention value may be calculated based on retention KPI's including or more strategic retention KPI's, one or more operational retention KPI's, or both, which provide a measure of performance related to customer retention of an entity. For example, the measure of customer retention may be based on a calculation (e.g., a summation) of one or more strategic retention KPI's as described herein. The measure of service quality may be based on a calculation (e.g., a summation) of one or more operational retention KPI's. In a particular embodiment, the customer retention value may be determined based on a calculation using a measure of customer retention, a measure of service quality, or both. To illustrate, the customer retention value may be based on a sum of the measure of customer retention and the measure of service quality.

A. Strategic Retention KPI's

Customer churn rate is a strategic KPI that may be a measure of customers that do not remain loyal to an entity. For example, customers that do not remain loyal may include customers that fail to repeat a purchase from the entity or cancel service with the entity. Customer loyalty may be determined by other measures that indicates a customer's willingness to stay or leave. In a particular embodiment, the customer churn rate may be calculated as a rate of a number of customers lost by the entity and a number of active customers. For example, the customer churn rate may be calculated by dividing a total number of lost customers (or customers that canceled service) during a time period divided by a total number of active customers during the time period.

Net promoter score (NPS) is a strategic KPI that may represent a measure of customer satisfaction with the entity. The Net Promoter Score® is a customer loyalty metric developed and registered as a trademark by Fred Reichheld, Bain & Company, and Satmetrix. In one example, the NPS may be calculated as a be a ratio of customers that would recommend an entity. Such a ratio may be useful because it gives an indication of a likelihood that customers may remain customers or use a service provided by the entity. The NPS may be proportional or related to customer experience where a ratio of customer that would recommend the entity is likely to have a positive customer experience, and vice versa. The NPS may be determined based on information obtained from a customer survey, such as answers indicating whether a customer is likely to recommend the entity to a friend. In a particular embodiment, the NPS may be calculated by determining a ratio of customers that promote (recommend) the entity to customer that detract from the entity. The ratio may be based on a value that is determined by subtracting a percentage of customers that detract from the entity from a percentage of customers that promote the entity. The customers that promote the entity may be customers that have given the entity a score that is equal to or above a particular threshold. For example, customers that promote the entity may have given a score of 9 or greater on a scale of 0 to 10. The customers that detract (do not promote) the entity may be customers that have given the entity a score that is equal to or less than a particular threshold. To illustrate, customers that detract from the entity may have given a score of 6 or less.

Customer satisfaction (CSAT) is a strategic KPI that may be a mean satisfaction value for customers for a particular experience. The mean satisfaction score may be based on information obtained from a survey. For example, the measure of customer satisfaction may be determined by calculating a mean satisfaction score of customer surveys. In a particular embodiment, the mean satisfaction score of a customer survey may be determined by an average of scores, each score for a particular question. In this embodiment, the score for each question may correspond to a value associated with a scale, where each answer is assigned a particular value in the scale corresponding to the answer chosen. The customer satisfaction may be determined by information obtained from a post-satisfaction survey.

Customer effort score (CES) is a strategic KPI that may indicate a measure of effort by a customer to perform an interaction (e.g., a task or a transaction) with the entity. CES may be defined as described in Dixon, Matthew et al, Stop Trying to Delight Your Customers, Harvard Business Review, July-August 2010. This reference is hereby incorporated by reference in its entirety for all purposes. The customer effort score may be determined based on a post-interaction survey. The score may be based on a scale, where each value corresponding to a particular amount of effort to perform the interaction. The CES may be based on a plurality of scores each indicating effort to perform a particular interaction. The plurality of scores may be used to determine an average or a score that represents customer effort for the entire survey.

B. Operational Retention KPI's

Emotional scoring is an operational KPI may indicate a score of comments (e.g., positive and negative comments) for an individual based on social interaction with the entity. Determining the emotional score may involve linguistic analysis of the comments made by the individual. The linguistic analysis may be performed by application of a scoring algorithm to the individual comments. The scoring algorithm may be applied to comments for a full life-cycle of a product or may be applied by aggregation to each segment of an entity with respect to a particular brand. In a particular embodiment, the customer experience calculation module 330 may be configured to access a linguistic emotion scoring application in the CRM system 310 or from a third party computing system to determine the emotional score for an individual.

Average resolution time is an operational KPI that may correspond to an amount of time for an entity to resolve a customer problem. The average resolution time may be segmented based on a reason associated with the customer problem and/or a channel (e.g., email, phone, or chat) used to communicate the customer problem. In a particular embodiment, the average resolution time may be measured as a mean time to resolve a problem from a time when a customer indicates the problem to the entity to a time when the problem is fully resolved.

Uptime is an operational KPI that may correspond to a measure of time that services provided by an entity are available to a customer. The measure of time may be a percentage of time. In a particular embodiment, the measure of time is determined by calculating an amount of time that a service provided by the entity is available during a period of time divided by a total amount of the period of time.

Channel accessibility is an operational KPI that may relate to accessibility of media resources (or channels) (e.g., Internet access, mobile communication, email communication, social networking access, etc.) to disabled persons. Accessibility relates to tools and resources (e.g., a screen reader or audio assistive technology) that are used to aid disabled persons in accessing the media resources. Accessibility may be defined based on accessibility standards, such as WCAG 2.0, US Section 508, UK Disability and Discrimination Act). In a particular embodiment, the channel accessibility is a measure, such as an amount, of options provided by an entity to permit disabled persons to access the entity from media resources.

Channel costs is an operational KPI that may be a measure of a cost of a customer interaction per channel of communication with an entity. In a particular embodiment, a channel cost may be measured based on a total cost associated with operating a particular channel of communication for a customer or all customers.

### 3. Efficiency Value

Operation efficiency may be an efficiency value that represents a ratio of delivery of services or products to cost. Operation efficiency may be based on measured values related to the efficiency of the entity, to cost of operation for the entity, and to productivity of the entity. The operation efficiency value may be determined using measures of factors that have a relationship or that affect operation efficiency. In a particular embodiment, the operation efficiency calculation module 336 may calculate an operation efficiency value based on a consideration of factors, such as a measure of strategic costs of the entity (e.g., a cost of sales for the entity, a cost of marketing for the entity, or a cost of service for the entity) and a measure of operating costs of the entity (e.g., cost of acquisition of a new customer, a cost of retention per customer, or a cost of handling a call for a customer). While embodiments described herein mention factors that may be used to determine a measure of operation efficiency, the operation efficiency value may be determined by other factors that express or affect an entity's ability to deliver results and reduce cost to the organization.

The operation efficiency value may be calculated based on efficiency KPI's including one or more strategic efficiency KPI's, one or more operational efficiency KPI's, or both, which provide a measure of performance related to operation efficiency of an entity. For example, the measure of strategic costs may be based on a calculation (e.g., a summation) of one or more strategic efficiency KPI's as described herein. The measure of operating costs may be based on a calculation (e.g., a summation) of one or more operational efficiency KPI's. In a particular embodiment, the operation efficiency value may be determined based calculation using a measure of strategic costs of the entity, a measure of operating costs of the entity, or both. For example, the operation efficiency value may be based on a sum of the measure of strategic costs of the entity and the measure of operating costs of the entity.

A. Strategic Efficiency KPIs

Cost of sales is a strategic KPI that may provide a measure of costs of sales of the entity. The cost of sales may be associated with sales of products, services, or both, by the entity. The cost of sales may be measured by determining a sum of costs associated with producing and/or selling a product or service. In a particular embodiment, the costs may include salaries for employees and costs for advertising (e.g., promotions, marketing, and ads).

Marketing costs is a strategic KPI that may provide a measure of costs associated with activities of the entity to promote a product or service offered by the entity, a brand of the entity, or both. In a particular embodiment, the marketing cost may be measured by determining a sum of costs associated with the activities for promotion, such as advertising, promotions, staffing, or a combination thereof.

Service costs is a strategic KPI that may provide a measure of costs associated with customer service, such as supporting a customer's use of a product, service, or both. Supporting a customer's use may include answering questions, resolving defects, handling returns, processing recalls, or a combination thereof. In a particular embodiment, the service costs may be measured by determining a sum of on-going costs for operating the entity to provide customer support for a product, a service, or both. The on-going costs may include costs associated with customer support and costs associated with technology infrastructure used to provide the customer support. The on-going costs may include research and development costs.

Cost per interaction/activity is a strategic KPI that may be related to a business cost associated with a business activity, such as processing/handling an item (e.g., a service, a product, a business process, or a combination thereof). Processing of an item may include communication involved with handling the item, interaction by an employee to handle the item, processing by computing infrastructure to handle processing (e.g., placing an order) for the item. In a particular embodiment, the cost per interaction may be determined by calculating a cost associated with handling each interaction for a particular item.

Self-service rate is a strategic KPI that may indicate a measure (e.g., a ratio or a percentage) of customer interaction with the entity using a self-service application (e.g., an Internet channel or an interactive voice communication system). In a particular embodiment, the self-service rate may be determined by calculating a measure of customer interaction with the entity performed without assistance from an agent divided by a total number of customers, such as a number of customer interactions handled by the entity (e.g., interactions handled by a particular set of communications services or channels).

B. Operational KPIs

Cost of acquisition (COA) is an operational KPI that may be a measure of costs associated with acquiring a new customer. In a particular embodiment, the COA may be determined by measuring an amount invested to acquire a new customer and dividing the amount invested by a total number of new customers. The amount invested in a new customer may include costs incurred to about the new customer, such as advertising, marketing, sales bonuses, or a combination thereof.

Cost of retention per customer is an operational KPI that may be a measure of costs associated with keeping a customer of an entity. The measure of costs associated with keeping an existing customer may be determined by determining costs associated with customer retention programs (e.g., incentive programs, loyalty programs, product/service markdowns, cancel/save programs) and dividing costs associated with customer retention programs by a total number of customers that were given an offer associated with a retention programs.

First contact resolution (FCR) is an operational KPI that may indicate a number of customers that resolved a customer service inquiry (e.g., a question, a phone call, a problem ticket, or a service request) on an initial (or first) request for customer service. In a particular embodiment, a measure of FCR may be determined based on a statistics maintained by the entity, a customer survey (e.g., a post-interaction survey).

Average handle time (AHT) is an operational KPI that may indicate a measure of time that the entity incurs to handle a customer interaction (e.g., a customer request). The customer interaction may include a customer service request, a communication between the customer and the entity, other interactions between the customer and the entity, or a combination thereof. The measure of time may include communication of the service request and follow-up communication after the service request has been completed. In a particular embodiment, the AHT may be determined by calculating an average amount of time spent by an entity to handle a customer interaction. The customer interaction may be considered for a time period that ranges from a time when an initial request is received to a time when the customer's issue has been resolved.

Initial training time is an operational KPI that may indicate a measure of time to train an employees) of the entity (e.g., an agent of the entity). The measure of time to train an employee(s) may include a time to training an employee(s) such that the employee can produce work that is productive to the entity. In a particular embodiment, the initial training time may be determined by calculating an amount of time to training an employee. The amount of time to train an employee may include time to retrain the employee.

Content effectiveness is an operational KPI that may indicate a measure of an amount of self-service content of an entity that has been accessed by one or more customers. The measure may be an average of self-service content accessed by a customer. In a particular embodiment, the content effectiveness may be determined by analyzing an amount of content (e.g., number of pages viewed or amount of content accessed) viewed on a website of the entity. In a particular embodiment, the amount of content accessed by a customer may be determined based on information accessed by the CRM system 310 from a third party computing system using a web analytics tool. For example, the third party computing system may provide a report that indicates a number of pages viewed per visit to the website of the entity.

Escalation percentage to assisted channels is an operational KPI that may indicate a measure of customers that escalate an issue to assisted customer service from a self-service function provided by an entity. The measure may be a ratio (or percentage) indicating a number of visitors that escalate an issue to a customer service agent after accessing a self-service function. In a particular embodiment, the measure of customers that escalate an issue may be determined based on information accessed by the CRM system 310 from a third particular computing system using a web analytics tool. In another particular embodiment, the customer experience management module 330 may communicate with the management module 322 to receive a customer report indicating information such as statistics associated with customer service that may be used to determine the measure of customers that escalate an issue.

Thus, an improved system for measuring customer experience enables an entity to consider many types of factors strategic and operational factors of different aspects of the business that directly or indirectly impact an entity. The application of operational and strategic performance indicators to determine customer experience enables the entity to selectively analyze customer experience from the entity's view rather than one based on consideration of a generic business model.

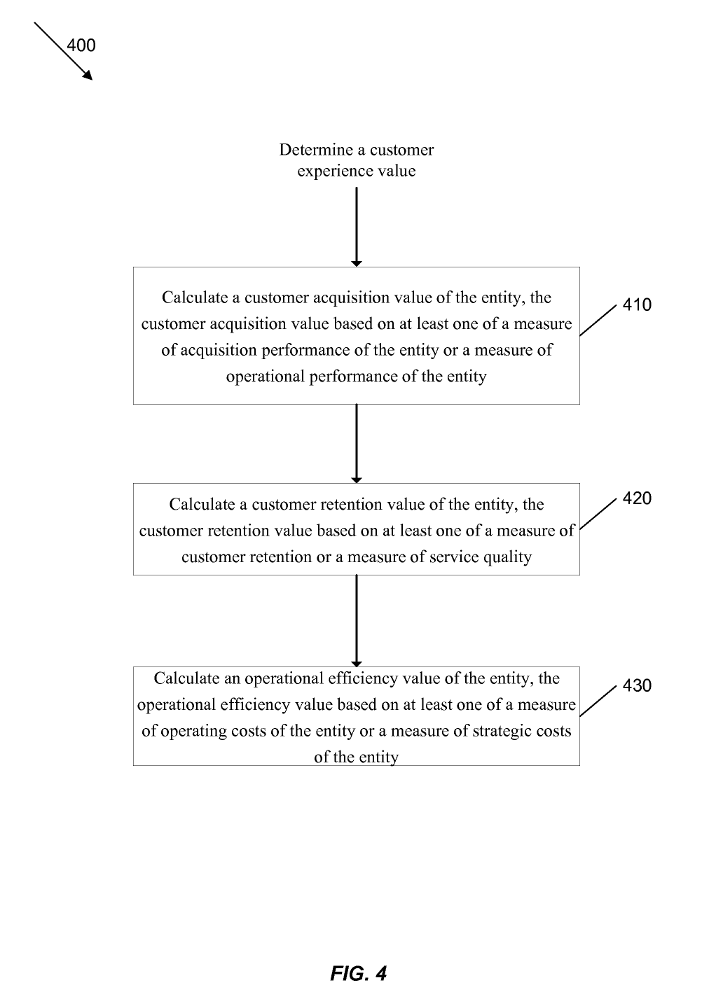

FIG. 4 is a flowchart illustrating a process performed according to one embodiment of the present invention, generally designated 400. The process 400 determines a customer experience value (CXV) according to one embodiment of the present invention and uses the CXV to indicate customer satisfaction based on the CXV.

The process 400 begins at 405 at which the CXV value is determined. The CXV may be determined based on a combination (e.g., a summation) of the customer acquisition value calculated at 410, the customer retention value calculated at 420, and the operation efficiency value calculated at 430.

At 410, the process 400 includes calculating a customer acquisition value of an entity. The customer acquisition value is based on at least one of a measure of acquisition performance of the entity or a measure of operational performance of the entity. To illustrate, a CRM system (e.g., the CRM system 310) may be operated by an entity to calculate a customer acquisition value for the entity based on a measure of acquisition performance and a measure of operational performance of the entity. In this example, an entity that conducts a significant portion of business through a website may be concerned with customer experience provided through the website. As such, to determine the customer acquisition value for assessment of customer experience of this entity, the entity may consider at least all traffic (e.g., direct traffic, indirect traffic, and unidentified traffic) conducted through the website and operational factors that indicate operation of the website, such as statistics associated with accessing and using the website. In this example, the customer experience management module 330 of the CRM system 310 may execute the customer acquisition calculation module 332 to calculate the customer acquisition value by calculating a sum of all traffic conducted through the website and a sum of values corresponding to operational indicators including a number of pages per visit of the website by a customer, frequency of visits by a customer of the website, and items per order by a customer of the website.

At 420, the process 400 continues by calculating a customer retention value of the entity. The customer retention value is based on at least one of a measure of customer retention or a measure of service quality. For example, an entity may utilize the CRM system 310 to calculate the customer retention value for the entity based on a summation of at least one of a measure of customer retention or a measure of service quality. To illustrate, taking the example of the entity that primarily conducts business through a website, the CRM system 310 may be configured such that the customer experience management module 330 calculates the measure of customer retention based on KPI's that are focused on metrics associated with operation of the website.

In this example, the customer experience management 330 may execute the customer retention calculation module 334 to determine measure of customer retention based at least on customer effort and customer satisfaction, both determined based on information provided by the CRM system 310 for surveys conducted through the entity's website. To consider metrics related to operation of the website, the customer retention calculation module 334 may determine the measure of service quality based at least on average resolution time and uptime for customers accessing the website. The customer retention value may be calculated based on a sum of the measure of customer retention and the measure of service quality.

At 430, the process 400 continues by calculating an operation efficiency value of the entity. The operation efficiency value may be based on at least one of a measure of operating costs of the entity or a measure of strategic costs of the entity. Continuing with the example of the entity that conducts business through a website, the entity may control the CRM system 310 to determine an operation efficiency value that based on customized KPI's that related to website operation. The customer experience management module 330 may execute the operation efficiency calculation module 336 to determine a operation efficiency value based on a sum of at least on strategic operational KPI's such as service costs for operating the website and cost per interaction to handle a transaction through the website, and operational KPI's such as average handle time and first contact resolution. The process ends at 430.

To determine the CXV, the customer experience management module 330 may determine a sum of the customer acquisition value calculated at 410, the customer retention value calculated at 420, and the operation efficiency value calculated at 430. The entity may assess customer experience based on analysis of the CXV. For example, the entity may compare the CXV to historical values to determine a change in the customer experience. The CRM system 310 may be configured by the entity with information indicating one or more ranges of predetermined CXV's that further enable the CRM system 310 for analysis to determine a status of customer experience when compared to the CXV. The one or more ranges of predetermined CXV's may be based on values for the KPI's considered to determine the CXV.

At 435, the process 400 includes using, by a CRM application at the server computer, the determined customer experience value to indicate a measure of customer satisfaction. For example, a CRM application operating in the server computer 320 of FIG. 3 may use the customer experience value determined by the customer experience management module 330 to indicate a measure of customer satisfaction. The CRM application may generate a report of customer satisfaction for presentation at the management UI 350. The report may indicate a measure of customer satisfaction that is determined based on a scale identifying a relationship of customer satisfaction to customer experience.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method comprising:
determining a customer experience value of an entity by a server computer, the customer experience value determined by:
calculating a customer acquisition value of the entity the customer acquisition value based on at least one of a measure of acquisition performance of the entity or a measure of operational performance of the entity;
calculating a customer retention value of the entity, the customer retention value based on at least one of a measure of customer retention or a measure of service quality; and
calculating an operation efficiency value of the entity, the operation efficiency value based on at least one of a measure of strategic costs of the entity or a measure of operating costs of the entity; and
using, by a customer relationship management (CRM) application at the server computer, the determined customer experience value to indicate a measure of customer satisfaction.

2. The method of claim 1, wherein the customer experience value is determined based on a sum of the customer acquisition value, the customer retention value, and the operation efficiency value.

3. The method of claim 1, wherein the measure of acquisition performance is based on at least one of a measure of customer traffic of the entity or a measure of marketing communication by the entity.

4. The method of claim 1, wherein the measure of acquisition performance is based on at least one of:
a ratio of completed sales transactions with the entity and a total number of interactions with the entity;
a ratio of customers acquired and a total number of customers during a time period; and
an average monetary value of an order corresponding to a product offered by the entity.

5. The method of claim 1, wherein the measure of operational performance is based on at least one of:
a ratio of marketing revenue of the entity and marketing investment of the entity, the revenue based on a difference between a net marketing revenue of the entity and the marketing investment;
a ratio of offers accepted by customers of the entity and a total number of offers made to the customers by the entity;
a measure of revenue gained for a customer of the entity; or
an average number of products, services, or both, ordered by a customer of the entity.

6. The method of claim 1, wherein the measure of customer retention is based on at least one of:
a rate of a number of customers lost by the entity and a number of active customers;
a measure of customers satisfaction with the entity; or
a measure of customer effort to perform a transaction with the entity.

7. The method of claim 1, wherein the measure of service quality is based on at least one of:
a linguistic emotional score of interaction by a customer with the entity;
an average amount of time to resolve a customer problem by the entity;
a measure of time a service provided by the entity is available; or
a measure of accessibility to media resources provided by the entity.

8. The method of claim 1, wherein the measure of strategic costs of the entity is based on at least one of:
a cost of sales of the entity, the cost of sales based on a product, a service, or both;
a cost of marketing of the entity for the product, the service, or both;
a cost of customer service for the product, the service, or both;
a cost of a particular type of business activity; or
a ratio of customers of the entity that receive self-service and a total number of customer of the entity.

9. The method of claim 8, wherein the particular type of business activity includes a customer service call, an online order, or both.

10. The method of claim 1, wherein the measure of operating costs of the entity is based on at least one of:
a cost to obtain a new customer of the entity;
a cost to keep an existing customer of the entity;
a number of services requests that are resolved after a first service request;
an average amount of time to provide service for a service request;
a training time period to train a new employee of the entity;
a measure of service support content of the entity viewed by a customer; or
a measure of customers that make a service request after accessing self-service content of the entity.

11. A system comprising:
a processor; and
a memory coupled with and readable by the processor and storing therein a set of instructions which, when executed by the processor, cause the processor to determine a customer experience value of an entity, the customer experience value determined by:
calculating a customer acquisition value of the entity the customer acquisition value based on at least one of a measure of acquisition performance of the entity or a measure of operational performance of the entity;
calculating a customer retention value of the entity, the customer retention value based on at least one of a measure of customer retention or a measure of service quality; and
calculating an operation efficiency value of the entity, the operation efficiency value based on at least one of a measure of strategic costs of the entity or a measure of operating costs of the entity.

12. The system of claim 11, wherein the processor and memory are included in a Customer Relationship Management (CRM) system.

13. The system of claim 11, wherein the customer experience value is determined based on a sum of the customer acquisition value, the customer retention value, and the operation efficiency value, wherein the customer acquisition value, the customer retention value, and the operation efficiency value are each calculated based on a particular weighted value.

14. The system of claim 11, wherein the measure of acquisition performance is based on at least one of a measure of direct customer traffic, a measure of indirect customer traffic, or a measure of unidentified customer traffic.

15. The system of claim 11, wherein the measure of operational performance is based on at least one of:
a ratio of offers accepted by customers of the entity and a total number of offers made to the customers by the entity;
a measure of visitors to a website associated with the entity, the measure of visitors based at least on an average number of visits to the website and an measure of repeat visitors to the website; or
a ratio of a number of new visitors to the website and the measure of repeat visitors.

16. The system of claim 15, wherein information of the measure of visitors to the website and the ratio of the number of new visitors and the measure of repeat visitors is obtained from a third party business analytics provider.

17. The system of claim 11, wherein the measure of operating costs of the entity is based on at least one of a cost to keep a customer of the entity or a measure of time to resolve a service request.

18. The system of claim 11, wherein the measure of customer retention is based on at least a measure of customer satisfaction with the entity, the measure of customer satisfaction determined by a mean satisfaction score of customer surveys.

19. A computer-readable memory comprising a set of instructions stored thereon which, when executed by a processor, cause the processor to determine a customer experience value of an entity, the customer experience value determined by:
calculating a customer acquisition value of the entity the customer acquisition value based on at least one of a measure of acquisition performance of the entity or a measure of operational performance of the entity;
calculating a customer retention value of the entity, the customer retention value based on at least one of a measure of customer retention or a measure of service quality; and
calculating an operation efficiency value of the entity, the operation efficiency value based on at least one of a measure of strategic costs of the entity or a measure of operating costs of the entity.

20. The computer-readable memory of claim 19, wherein the customer experience value is determined based on a sum of the customer acquisition value, the customer retention value, and the operation efficiency value.
